(19) United States
(12) Patent Application Publication
(10) Pub. No.: US 2010/0083145 A1
(43) Pub. Date: Apr. 1, 2010

(54) Service Performance Manager with Obligation-Bound Service Level Agreements and Patterns for Mitigation and Autoprotection

(75) Inventors: Thierry E. Schang, Mountain View, CA (US); Arun L. Katkere, Los Gatos, TX (US); Asquith A. Bailey, East Palo Alto, CA (US)

Correspondence Address: BAKER & MCKENZIE LLP;PATENT DEPARTMENT, 2001 ROSS AVENUE, SUITE 2300, DALLAS, TX, 75201, US

(73) Assignee: TIBCO SOFTWARE INC., Palo Alto, CA (US)

(21) Appl. No.: 12/432,738

(22) Filed: Apr. 29, 2009

Related U.S. Application Data
(60) Provisional application No. 61/048,932, filed on Apr. 29, 2008.

(51) Int. Cl. G06F 15/173; G06F 3/01; G06F 9/46

(52) U.S. Cl. 715/760; 709/224; 719/318

(57) ABSTRACT

The disclosed Service Performance Manager is an enterprise software platform that monitors and proactively manages the health and performance of both individual and grouped services based on service level agreements, providing better visibility and control over individual and group services including, but not limited to, IT and business services. The Service Performance Manager predicts and solves potential customer-related issues before customers are aware of them, enabling an organization to meet quality of services objectives. Unlike other software platforms, the disclosed service performance manager automatically optimizes resources, services and service level agreements with finer granularity and precision, while remaining steadfastly vendor neutral, allowing the Service Performance Manager to manage many different applications and Service Oriented Architecture platforms simultaneously. The disclosed Service Performance Manager allows the user to monitor and manage the performance of individual or grouped services, and provides the visibility in service monitoring from both, technical and business perspectives.

### CROSS-REFERENCE TO RELATED APPLICATIONS

This patent application relates and claims priority to provisional patent application 61/048,932, entitled “Service Performance Manager with Obligation-Bound Service Level Agreements (SLA) and Patterns for Mitigation and Autoprotection,” filed Apr. 29, 2008, which is herein incorporated by reference for all purposes.

### BACKGROUND

1. Technical Field

The disclosed embodiments relate generally to Service-Oriented Architecture system management and, more specifically, to a Service Performance Manager software platform with conditional Service Level Agreement and issue mitigation and autoprotection features.

2. Background

Service oriented architecture (SOA) is rapidly being adopted and deployed by many different organizations in all industries and sizes. With the focus and attention squarely on implementing SOAs, organizations have generally paid little attention to monitoring and managing their SOAs to ensure that service levels are maintained and efficiencies increased.

### BRIEF SUMMARY

The disclosed Service Performance Manager (SPM) is an enterprise software platform that monitors and proactively manages the health and performance of both individual and grouped services based on Service Level Agreements (SLAs). The SPM provides enhanced visibility of running services, allows for automatic deployment of extra service instances in order to meet load spikes, and helps ensure that SLAs are not violated during the unexpected spikes. The SPM also allows for rules to monitor service performance, service availability, and service usage. The SPM provides IT and operations managers better visibility and control over their IT and business services. The SPM predicts and solves potential customer-related issues before customers are aware of them, enabling an organization to meet quality of services objectives. Unlike other software platforms, the disclosed SPM automatically optimizes resources, services and SLAs with finer granularity and precision, while remaining steadfastly vendor neutral, allowing the SPM to manage many different applications and Service-Oriented Architecture (SOA) platforms substantially simultaneously. The disclosed SPM allows a user to monitor and manage the performance of individual or grouped services, and provides visibility in service monitoring from both a technical and a business perspective.

### BRIEF DESCRIPTION OF THE DRAWINGS

Embodiments are illustrated by way of example in the accompanying figures, in which like reference numbers indicate similar parts, and in which:

FIG. 1 provides an illustration depicting an exemplary selection of items that may be monitored by the disclosed SPM, in accordance with the present disclosure;

FIG. 2 illustrates an exemplary loan sanction process flow chart, in accordance with the present disclosure;

FIG. 3 illustrates a diagram of the basic project workflow of the disclosed SPM, in accordance with the present disclosure;

FIG. 4 illustrates a diagram of the user workflow for the disclosed SPM, in accordance with the present disclosure;

FIG. 5 illustrates a diagram of the user workflow for the disclosed SPM, in accordance with the present disclosure;

FIG. 6 illustrates a diagram of the user workflow for the disclosed SPM, in accordance with the present disclosure;

FIG. 7 provides a diagram illustrating the SPM Product Architecture, in accordance with the present disclosure;

FIG. 8 illustrates a flow chart detailing a simple rule and a complex rule, in accordance with the present disclosure;

FIG. 9 illustrates a flow chart displaying the steps for setting a rule, in accordance with the present disclosure;

FIG. 10 provides a schematic illustration of a rule package featuring an objective with four rules, in accordance with the present disclosure;

FIG. 11 provides a diagram depicting the organization of a collection of rules in a rule package, in accordance with the present disclosure;

FIG. 12 provides a list of referenced target object types, in accordance with the present disclosure;

FIG. 13 illustrates a flow chart of the service consumer obligation and application to SOA auto protection, in accordance with the present disclosure; and

FIG. 14 is a block diagram illustrating a computer system for implementing one embodiment of an SPM, in accordance with the present disclosure.

### DETAILED DESCRIPTION

### Service Performance Manager

Service Performance Management is the ability to monitor and measure the observable behavior of individual or grouped services, and to implement changes (reactively or proactively) to their behavior based on a defined set of rules. Observable behavior may include system performance, availability, usage, faults, and payload.

The disclosed Service Performance Management system is a software platform that maintains and automatically manages the health and performance of the observable behavior of individual or grouped services, while additionally managing business payload. In an embodiment, the SPM maintains and manages the health and performance of the observable behavior of IT services. In another embodiment, the SPM maintains and manages the health and performance of the observable behavior of business services. The SPM may be used to design, plan and monitor services based on business needs. The SPM may also be used to balance service levels against the costs. In addition, the SPM may be used to achieve and enforce measurable levels of service and reduce likelihood of unpredictable demands. The SPM may dramatically improve relationships between service providers and customers. Disclosed embodiments of the SPM include properties that feature obligation-bound service level agreements (SLAs), and patterns for recognizing component misbehavior.

The SPM may use policy management techniques to distribute listeners and associated policies and also to gather performance information. With the combination of complex event processing, rules, policies, and Java Management Extensions (JMX) control interfaces, the SPM allows a user to create substantially any reaction scenario to service level exceptions or anomalies.

The SPM allows users to monitor deployed service artifacts through use of a distributed monitoring and instrumentation framework. In an embodiment, the user may monitor deployed service artifacts through use of a dashboard to track metrics from a service perspective, independent of the deployment infrastructure.

In an embodiment, the SPM may be added to an existing SOA infrastructure. The SPM may be added to a variety of technologies and architectures.

The SPM may provide autonomic capability to SOA fabric including using SLAs in conjunction with monitoring, providing proactive and reactive alerting on threshold violations or impending violations, and providing assurance (both self-healing and self-optimizing) where possible in both usage and performance.

In an embodiment, the SPM provides for wizard based creation of SLAs and rules.

The SPM not only provides users with substantially instant visibility into their running services, but also allows them to set up automatic deployment of extra service instances in order to meet load spikes. This may ensure that service level agreements are not violated during the unexpected peaks, and may allow users to set up rules to monitor service metrics including, but not limited to, system performance, availability, and usage. If an incident or violation occurs, it may be handled through an alert on the user interface or dashboard or through email. In an embodiment, a business process management (BPM) or customer relationship management (CRM) workflow may be initiated.

The SPM not only helps monitor services, but may also assist in managing those services. The SPM allows the user to monitor the key performance indicators in a business process, analyze the performance, check the behavioral pattern, and take corrective actions in proactive and predictive ways to manage and run the business successfully. Based on past performance, the user may predict future performance, identify bottle necks, and take corrective actions for better performance. In certain scenarios, the user may be proactive and setup rules to trigger actions if certain conditions are met or if certain rules are violated, thus providing a level of assurance to the user.

Rule libraries may be created using the SPM, in which simple or complex rules may be defined on some service metrics. These rules may internally trigger one or more types of actions if the conditions defined in the rules are met. The action library may store exemplary actions such as sending an alert, invoking a script or a service, or logging an event. Some rules may be run on recurring schedules such as, for example, Everyday at 2 PM, on all week days, or on peak hours. Standard schedules may be defined in the schedule library, which may be used to trigger actions at a specified time based on a corresponding rule.

In an embodiment, the SPM provides low cost of administration through centralized management and self-managing protocols, ensuring better compliance and SOA governance. In another embodiment, more efficient operations management and quality control are achieved. The SPM may allow for easier measurement and determination of SLAs. In an embodiment, the addition of SPM for end to end enterprise infrastructure monitoring and managing provides the ability to predict and respond to a myriad of business services and events.

### Business Scenario

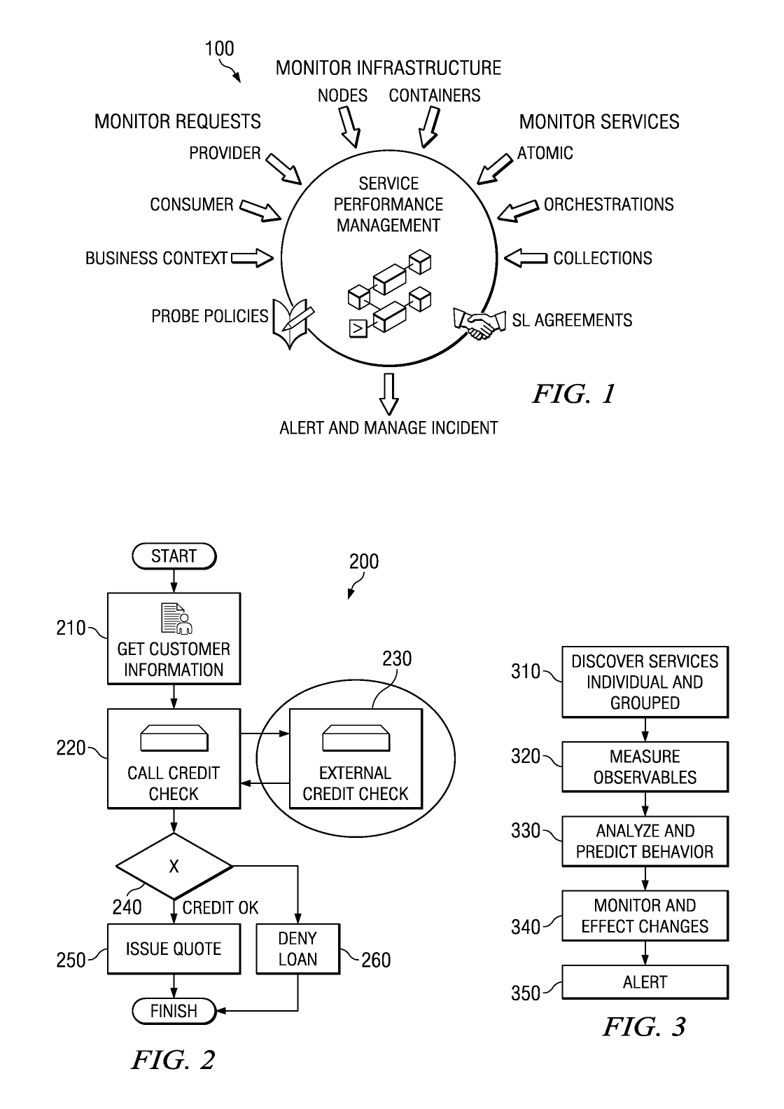

In a typical business scenario, there are service providers and service consumers. Irrespective of the user's role as a service provider or service consumer, the SPM may be used for monitoring and managing the business services. FIG. 1 is a diagram 100 depicting an exemplary selection of items that may be monitored by an embodiment of the disclosed SPM. The disclosed SPM may monitor requests, infrastructure, and services including, but not limited to, monitoring requests from a provider or consumer or requests in a business context; monitoring infrastructure nodes or containers; and monitoring atomic, orchestrations, or collections services. In an embodiment, the SPM uses probe policies and/or SLAs in conjunction with monitoring requests, infrastructure, and services to manage incidents and provide alerts.

FIG. 2 provides a flow chart to illustrate an embodiment of how the SPM may be used in an exemplary loan sanction process 200. The first step in the exemplary process is to retrieve the customer's information 210. In the next step, the customer's credit is checked 220 using an external credit check service 230. In an embodiment, the credit check service is external and may have a guaranteed availability of 99.9%. Based on a determination of whether the credit is acceptable or not 240, the quote is either issued or the loan is denied. If the credit is acceptable, then a quote is issued 250, otherwise, the loan is denied 260. The SPM is used in this example to monitor the availability, response, and data trafficking between the external credit check service 230 and a loan company.

In an embodiment, if the guaranteed availability of an external service, such as the credit check service presented in FIG. 2, is not met, then a service consumer may log the event, alert an administrator, initiate a support request, and/or initiate the billing of penalties.

In an embodiment, a service provider may wish to ensure a guaranteed response to all requests within a time specified in an SLA. For example, if a consumer overloads the system by sending too many requests which are abnormally large in quantity or have faulty payloads, a service provider may choose to take corrective actions to keep the system load under control. Such corrective actions may include blocking further requests so that the entire system does not become impaired, or alerting other parties. To repair the faulty or overloaded services, the system administrator may choose to throw more grid resources (assign additional computing resources), reallocate existing resources, or select which requests to process.

### Project Life Cycle

FIG. 3 is a diagram illustrating the basic project workflow of an embodiment of the disclosed SPM. The major steps involved in monitoring and managing service level performance are discovering services 310, measuring observable metrics 320, analyzing and predicting behavior 330, monitoring services 340, and sending alerts 350.

In the discovering services step 310, the SPM may check for all the services running in a single or multiple environments. These services may be individual or grouped services such as service assemblies or service units. The SPM may also check for service dependencies, composite services, and service references. The SPM may also check for SLAs defined on each service and party and thresholds defined for each service.

Once the services and the consumer and provider parties for those services are identified, the next step is to measure observables 320, or measure the metrics values. Some of the measurable metrics may include service metrics, infrastructure metrics, and business metrics from payload. Service metrics may include throughput, latency, request size, faults, and availability signals; infrastructure metrics may include capacity, memory, and information about the central processing unit (CPU); and business metrics from payload may include user identity or role, source, and transaction value. In an embodiment, business metrics may be extracted directly from the content or envelope of a request. For example, the user identity, the origin of the request, or a transaction amount in Dollars or Euros may be used to associate a value by which to priority a request. Metrics may also be gathered about the physical deployment architecture that can be gathered through JMX instruments.

After the metrics and their values are gathered over a time period, the data may be analyzed and the future data requirement may be predicted in the analyze and predict behavior step 330. The data may be analyzed by computation and aggregation. Certain behavioral patterns may be identified which may help to predict the future data requirement. A statistical and time-based analysis may be performed in which the average, minimum, and maximum values are calculated in addition to the values for the moving time frame window, and the values for the last hour, day, week, or month. An infrastructure aggregate calculation may be performed in which the metrics value by node and metric value by container are calculated. A functional aggregate calculation may be performed in which the metrics value by service assembly and metrics value by service unit are calculated. A business aggregate calculation may be performed in which the metrics value by client and metrics value by amount are calculated. Finally, a customer-based aggregate analysis may be performed in which metric values by customer role (e.g. gold, silver, and platinum) are derived and aggregated.

The next step is the analyzing and predicting behavior step 330. Any of these metrics may be displayed in a web-based dashboard which may contain some pre-defined views. In an embodiment, these metrics may provide real-time values by fetching data every minute and updating the values of the metrics. Various views may be configured to monitor performance at various levels such as environment, machine, node, service assembly, and service units. The dashboard may be personalized as necessary for a particular business's need to get real-time updates including, but not limited to, service availability, service usage, service faults, business payload. To monitor services using the disclosed SPM, rule packages and rules may be defined, and target objects may be selected to apply the rules. In an embodiment, these objects are called referenced target objects. Additionally, conditions may be set on the default metrics available for the selected target objects, schedules may be created to run the rule at the scheduled time, and actions may be defined and associated with rules for managing the service performance. The actions may be a default action or a custom action. When a rule is enabled, the system may start monitoring all the referenced target objects for the specified set of conditions defined in the rule. When the metrics value reaches the threshold condition, the rule is triggered, which in turn initiates an action to manage the performance within the specified limits. In an embodiment, based on the SLA between service consumers and providers, a set of rules may be defined. These rules are able to be monitored as well as customized, which helps both the consumer and provider to track the service execution and adhere to service level business agreements.

Threshold conditions may be defined on metric values and rules may be set based on the metrics. When these threshold levels are reached or conditions defined in a rule are met, one or more alerts or actions may be triggered 350. In an embodiment, if there are any violations in the SLA, alerts are sent. Alerts may be displayed in the dashboard as visual indicators. At times, these alerts may internally trigger certain actions including, but not limited to, running a script, logging an event, or sending a mail notification.

In an embodiment, in addition to alerts, certain corrective actions may also be set to execute in a rule. When the conditions in a rule are met, these corrective actions may automatically be executed, which may help business continuity. Some of the corrective actions may include automatic resource allocation, starting a node, or incident management.

### User Workflow

In an embodiment, a high-level overview of the major steps involved in implementing an SPM in a business includes identifying technical requirements, configuring the system and monitoring the performance, and managing the system.

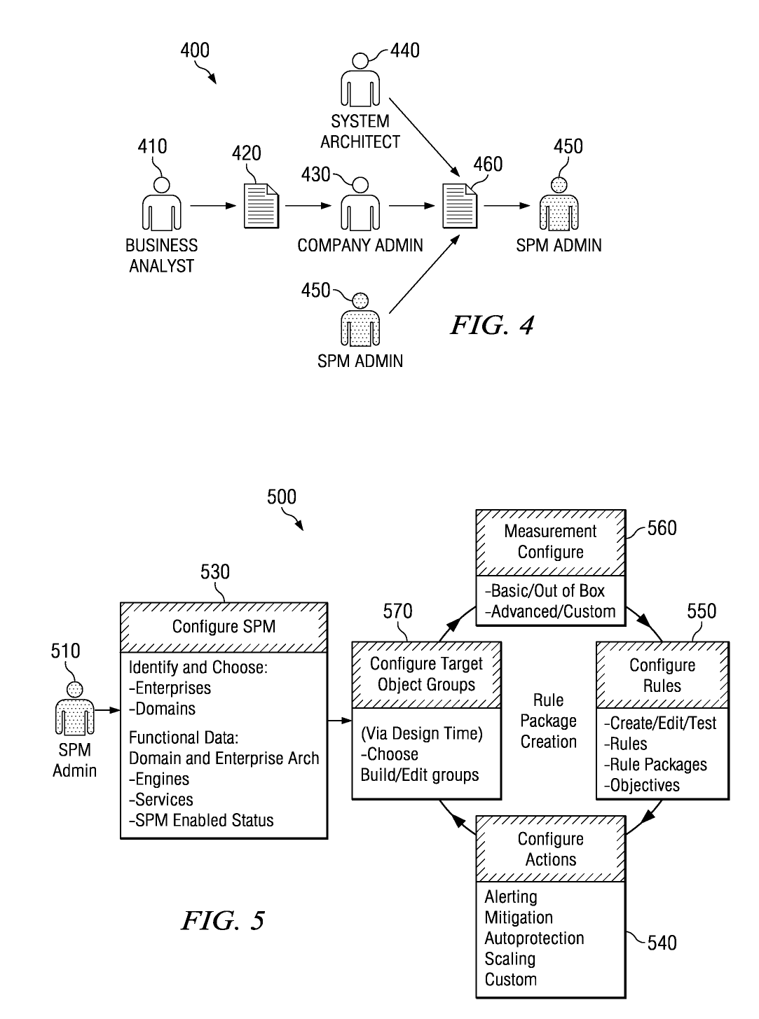

FIG. 4 is a diagram 400 illustrating the user workflow for identifying technical requirements. This may involve setting the technical requirements of a business. In an embodiment, a business analyst 410 identifies all the services used in the business and provides data 420 to setup and configure the SPM. This data may include business requirements at all service levels. The data 420 is provided to a system administrator 430. Then information including, but not limited to, information from the system administrator 430, a system architect 440, and a SPM administrator 450, as well as other information, may be compiled to determine technical requirements 460 including, but not limited to, requirements for services, rules, actions, nodes, and machines. To measure the performance of the business services, the monitoring points, such as services, process, machines, and nodes, are determined. The data is provided to an SPM administrator 450 and may guide the setup and configuration of the SPM.

FIG. 5 is a diagram 500 illustrating the user workflow for configuring the system and performance monitoring rules. The domains and environments may be configured 530 by an SPM administrator 510. Configuration 530 may include an SPM administrator 510 identifying all the environments and domains to be managed by an SPM instance, identifying all the service containers, and/or identifying all the services in those environments and domains. After identifying service containers and services, an SPM administrator may also configure or define target objects groups 570 to group target objects into logical groups. For example, in an embodiment, the SPM administrator may choose to put all services with gold SLA requirements into one target object group and all other services into another target object group. Before defining rules on the target object groups 570, the SPM administrator examines the out metrics available to assess whether they are sufficient 560. If any custom metric is required, to either classify existing metrics or to accumulate a new numeric metric, the SPM administrator defines custom metrics 560. Based on SLAs or informal expectations of service performance, the SPM administrator defines rules on target object groups and organizes them into objectives and rule packages 550. SPM administrator defines the actions taken when a rule triggers or clears for a particular target object 540. Actions include alerting a set of users, mitigation actions, scaling actions such as provisioning a new service container (node/engine) or deploying the service to a new service container, auto-protections such as blocking a user sending too many requests, or an administrator-defined custom action. In an embodiment, an administrator 510 of the SPM may use a build and configure rules perspective to define rules on a group of selected target objects. The appropriate services are grouped as target object groups and rules are defined on them. These rules may contain conditions defined on service metrics. Rules may also be associated with custom actions which are automatically triggered when certain conditions in a rule are met. A view and manage dashboard perspective displays the metrics data in various formats such as charts and reports.

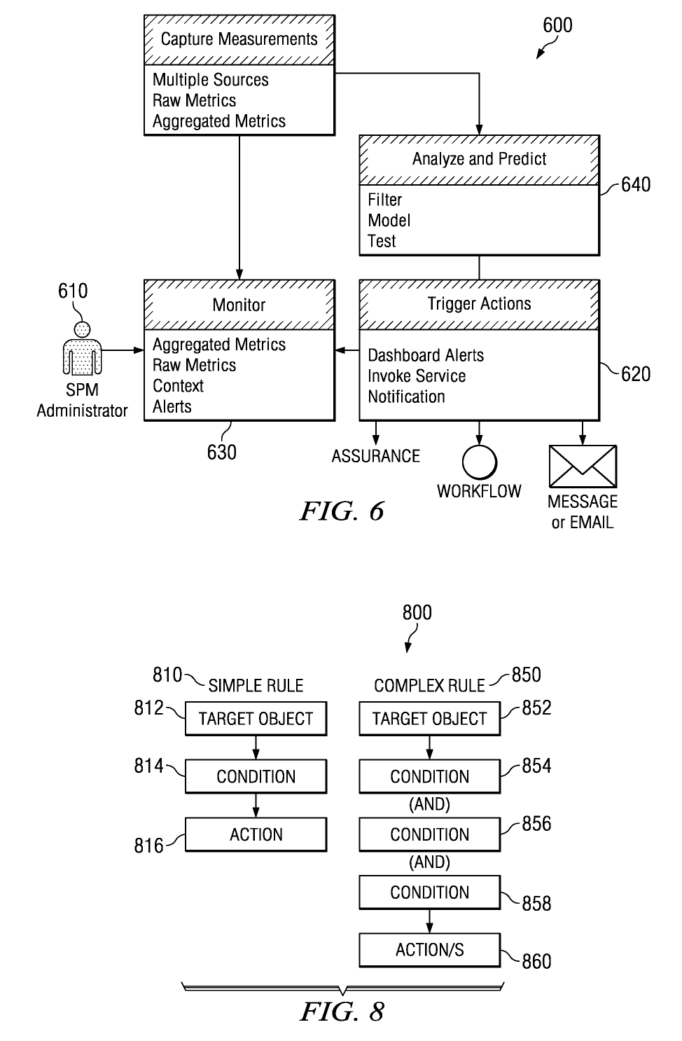

FIG. 6 is a diagram 600 illustrating the user workflow for monitoring and managing the system. The SPM administrator 610 may interactively monitor the system 630 by viewing a dashboard of raw and aggregated metrics with related context information such as deployment details, machine and node information, and generated alerts. If rules are defined, the system will compare the measurements 640 against defined rule condition thresholds and trigger actions 620 if necessary. Thresholds may be dynamically generated by an external system by analyzing historic performance of the metric. Testing and simulation may be used to generate the threshold values to compare against. Assurance actions 620 may include autoprotection actions such as blocking requests until the triggering condition has been mitigated, provisioning new resources (scaling) until the triggering condition has been mitigated, triggering a manual workflow to have an administrator manually mitigate the issue (e.g., restart a database, provision new hardware, etc.). Manual mitigation can also be triggered by generating an alert message (email or other message). When a condition is defined and a rule is met, the rule may trigger an action 620. The action may be, for example, Send Notification, Send Alert, Invoke Script, or Add a Node. The actions help an SPM administrator 610 manage the system performance and make sure that the system is reliable.

### Product Architecture

The architecture of the disclosed SPM may contain groups including, but not limited to, a user interface plugged into an administrator of a service oriented architecture service platform, back-end web services integrated into a service oriented architecture service platform, and system services such as rules service and action service deployed into a service oriented architecture service platform foundation. In an embodiment, the disclosed SPM may be integrated into a TIBCO ActiveMatrix® service platform.

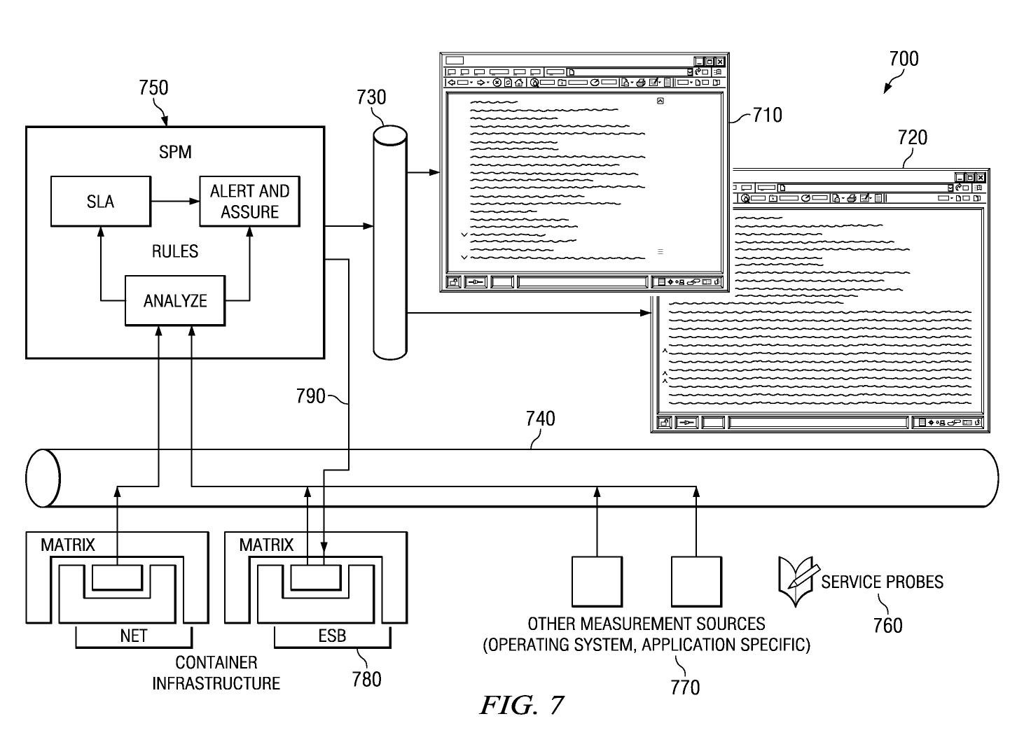

FIG. 7 is a diagram 700 illustrating an embodiment of the SPM product architecture. The SPM includes various categories of probes 760 to monitor the data pertinent to SOA platforms. In an embodiment, the probes are directly embedded inside the container infrastructure 780. Probes may also measure information from other integration software or application software 770 which provide services in the SOA. Additional probes 770 may measure relevant information about each computer operating system to provide additional context such as CPU, memory, and network usage. In an embodiment, SPM probes may be enhanced to support custom metrics. For example, SPM probes may extract business information from a service request payload, providing additional context about the importance of the request. Information gathered by the probes may be distributed to the SPM system services 750 through a real time instrumentation bus 740. In an embodiment, the SPM may contain run-time node service probes 760 to monitor the data pertinent to TIBCO ActiveMatrix® and/or TIBCO BusinessWorks™.

The SPM system services typically run on an isolated SPM system environment 750 on one or multiple specially provisioned nodes and hardware. In an embodiment, all services specific to the SPM are hosted on a node named “spmnode” in a separate “spmenv” environment. In an embodiment, the “spmenv” environment is kept separate, and not used for any business services. The SPM system services may include, among other services, a rule service, an action manager service, a standard action service, and an alert server. A rules service may collect and aggregate basic and custom metrics, may translate and deploy SPM rules, and may send rule triggers or clear messages to an action manager service. An action manager service may handle rule actions, for example sending an alert, invoking a service, or making a log, on either a rule triggers or clear messages, and on an assurance 790 like blocking further requests or provisioning new computing resources. The action manager service may generate messages using templates for alerts. A standard action service may deploy services on additional existing nodes, deploy service on additional nodes by provisioning a new node, invoke scripts on a machine, generate Simple Network Management Protocol (SNMP) asynchronous notification messages or “traps,” and provide support for integration software for service oriented architecture service platforms engine control methods. Actions are distributed back to the nodes for execution through a Management Bus 740. An alert server allows a user to specify email format (e.g., text or HTML) and email delivery method (e.g., digest mode).

In an embodiment, integration software for SOA service platforms includes TIBCO BusinessWorks™.

A user interface (UI) of the SPM is plugged into an administrator of an SOA service platform administrator. The user interface includes a perspective to build and configure rules as well as a perspective for viewing and managing dashboards including, but not limited to, a monitoring dashboard 710 and a SLA dashboard 720. Additionally, the UI may support monitoring custom metrics, including defining a custom metric to monitor and manage performance of any service. Real time updates of the performance measurements and alerts are distributed to the dashboard through a real time messaging bus, or dashboard bus, 730.

A command line interface (CLI) (not shown) supports substantially all actions performed from the UI. The CLI may also support defining alerting templates and using them for email notifications. The web services to support the SPM UI and CLI may be plugged into a service oriented architecture service platform server via a standard http protocol as well as a real time asynchronous communication bus 730. These web services fetch the data and then display the data to the user.

In an embodiment, a machine agent runs on all management daemons where remote script execution and enhanced machine metrics extraction are desired.

### Rules

In an embodiment, by building and configuring various rules, a user may monitor and manage the system performance using the SPM. A rule defines conditions for monitoring target objects. A rule may also specify an action to be taken on the selected target objects when the specified condition is met.

In an embodiment, rules are the basic building blocks of the SPM. There are two types of rules, simple rules and complex rules. FIG. 8 illustrates a flow chart 800 illustrating a simple rule 810 and a complex rule 850. A simple rule 810 may have a target object 812, a condition 814, and an action 816. In an embodiment, a simple statement is created to trigger one or more types of actions 816 (for example, send an alert, invoke a script or service, or log event). A complex rule 850 may have a target object 852, may have more than one condition 854, 856, 858, and an action 860. In an embodiment, a complex rule 850 includes AND logic. A complex rule 850 may trigger more than one action 860. In an embodiment, a condition 814, 854, 856, 858 is defined based on the default metrics available for the selected target object.

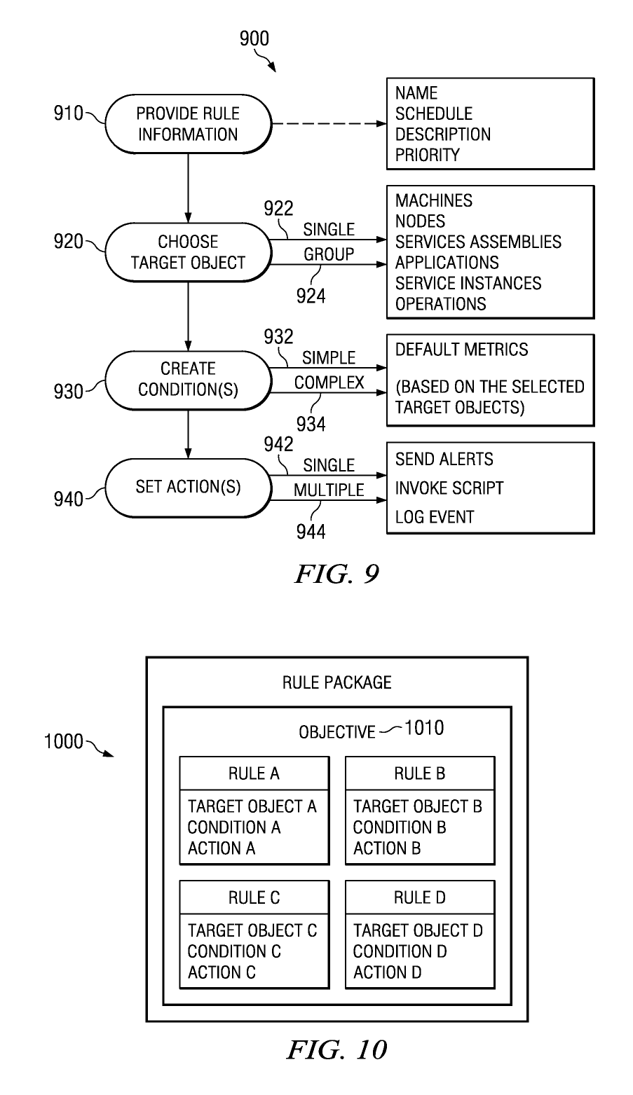

FIG. 9 is a flow chart 900 illustrating the steps used for setting or creating a rule. In an embodiment, once a new rule is created, it may be stored in a rule library. The main steps for creating a rule include providing basic rule information 910, choosing a target object 920, creating conditions 930, and setting actions 940.

Providing basic rule information 910 may include providing information such as name and description. In an embodiment, providing basic rule information 910 may also include specifying the schedule for running the rule from a pre-defined schedule in a schedule library. In another embodiment, providing basic rule information 910 may also include setting priority for rules.

Choosing a target object 920 may include choosing either a single target object 922 or a group of target objects 924. A group of target objects 924 may be formed of objects that are of the same type or have a shared criteria. Target objects 922, 924 may be machines, nodes, service assemblies, service instances, or operations. In an embodiment, the target objects are selected from an infrastructure or deployment views of the TIBCO ActiveMatrix® environment or domain. In an embodiment, the TIBCO BusinessWorks™ Service Probe is installed and BusinessWorks™ services and processes may be selected as target objects.

Depending on the target object selected, the relevant metrics are made available for creating a condition 930. A condition may be simple 932 or complex 934. In an embodiment, a complex rule 934 may include adding up to three conditions using logical AND operators. Conditions may be validated at run-time and, when the specified criteria are fulfilled, an action may be triggered.

Setting actions 940 includes setting the actions to be taken when any condition defined in a rule is satisfied. Single 942 or multiple 944 actions may be taken for any given condition. An action may be set to, for example, send alerts, invoke a script, or log events.

### Rule Packages

A rule may be a standalone rule, or is may be part of an objective which belongs to a rule package. FIG. 10 provides a schematic illustration of a rule package 1000 featuring an objective 1010 with rules A, B, C, D with target object A, B, C, D, conditions A, B, C, D, and actions A, B, C, D, respectively.

An objective is a collection of rules intended to achieve a definite goal. The objective can impose common metadata, schedules, and actions on the rules contained within it. In an embodiment, a set of objectives packaged to achieve business goals is called a rule package. Rule packages may be organized by the business roles, which are based on the level of service the rule package represents.

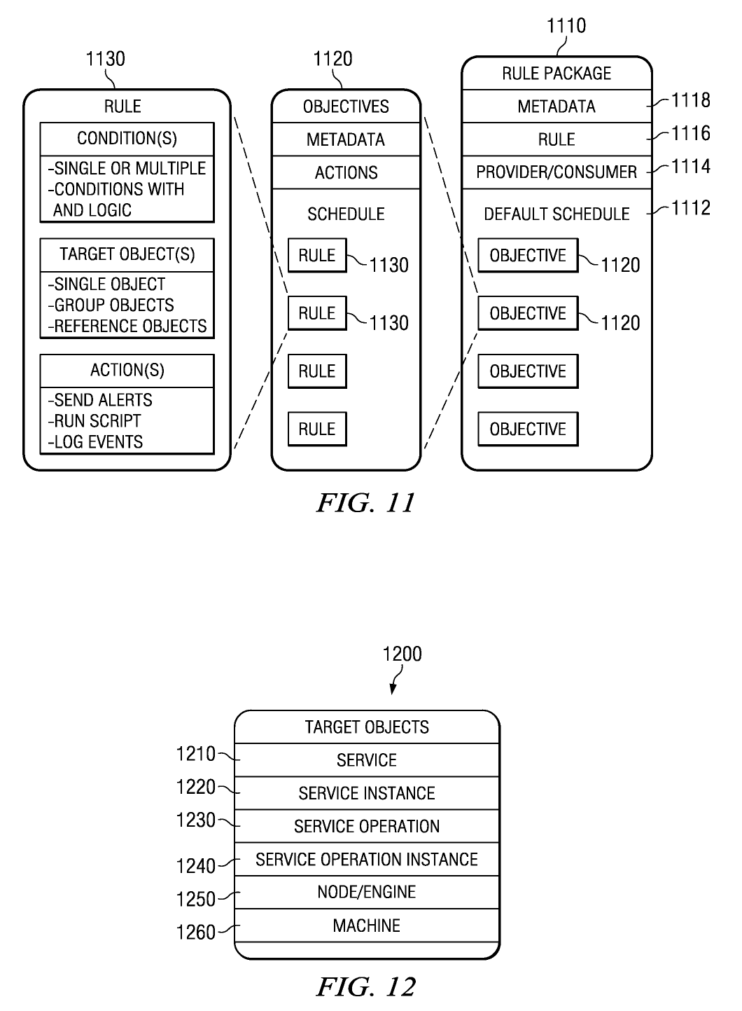

FIG. 11 provides a diagram depicting the organization of a collection of rules in an exemplary rule package 1110. In an embodiment, a rule package is a digital manifestation of an SLA. A rule package may be as simple as one rule, or as complicated as hundreds of rules grouped together based on common objectives. A rule package 1110 contains one or more objectives 1120, and an objective contains one or more rules 1130. The objectives may be created while creating a new rule package. Rule packages hold a default objective schedule 1112, so that any objectives created without a schedule have a default schedule to use. In an embodiment, the default schedule 1112 is set to “Always,” so that a schedule is always applied. Rule packages 1110 may also impose common metadata 1118 on the objectives 1120 contained within the rule packages. Rule packages 1110 have the option to identify the provider and consumer parties in the SLA 1114, as well as optionally identify the level of service the rule package represents (the role) 1116, thus the parties and roles are optional fields. In an embodiment, to access a rule package, a user should select a rule package from the build and configure perspective.

### Referenced Target Objects

A referenced target object is a target object that is referenced by one or more rules. The conditions defined in the rule are validated against the selected target objects. If a condition is violated, the rule is triggered to send an alert. If the rule is associated with an action, the action takes corrective measures and tries to bring the performance within the specified condition. FIG. 12 provides a list of referenced target object types 1200. The referenced target object types may include service types 1210, service instance types 1220, service operation types 1230, service operation instance types 1240, environment or domain types, machine types 1260, and node or engine types 1250. In an embodiment, service types 1210, service instance types 1220, service operation types 1230, service operation instance types 1240, and environment or domain types, may include select TIBCO ActiveMatrix® or TIBCO BusinessWorks™ services, service instances, service operations or processes, service operation instances or process instances, and environments or domains. Machine types 1260 may include a machine on which TIBCO ActiveMatrix® or TIBCO BusinessWorks™ is running Node or engine types 1250 may include a TIBCO ActiveMatrix® node or a TIBCO BusinessWorks™ engine. Both individual users and super users may access a referenced target object library to view, delete, or reselect the referenced target objects.

### Schedules

A schedule defines a recurring time period during which a rule, objective, or rule package is run. In an embodiment, the schedule set for a rule applies only if the rule is a stand-alone rule, and not belonging to a rule package or objective. In an embodiment, if the rule is in an objective, the objective schedule takes precedence or, in other words, by default, when a rule is added to an objective, the schedule is not copied. A rule package contains the default schedule for all objectives in the rule package, which is used when an objective has no schedule of its own; however, an objective is not required to have a schedule.

A schedule may contain “include” and “exclude” time periods that control when associated rules should or should not be run. For example, a schedule called “Peak Hours” could include the hours from 9 PM to midnight daily for all months of the year, but exclude the hours from 3 AM to 6 AM for January. In an embodiment, multiple include and exclude time periods for a single schedule are defined.

In an embodiment, the SPM supports global schedules, owned by super users, and schedules owned by individuals.

A super user is a user with the privilege of creating and managing global schedules, including the out-of-the-box schedules. Global schedules are available to all users. A super user may also delete and edit schedules created by individual users, and duplicate a user-owned schedule and save it as a global schedule.

An individual user can see and duplicate all schedules in the library, edit the schedules owned by the individual user, see and use global schedules or their own schedules in the schedule drop-down list in the rule builder, and create rule package builder dialogs. An individual user may replace an owned schedule with another owned schedule or with a global schedule. A schedule can be replaced either universally (replace the old schedule with the new schedule everywhere it is used) or individually (navigate through all the locations it is used, and replace it with another schedule). An individual user can also delete owned schedules that are not used anywhere.

### Custom Actions

In an embodiment, the SPM includes an action library. The action library contains a list of web services. These services may automatically perform service management tasks and save administrator time. The scope of what a service can do depends on how the web service is written. A service is configured to apply to a specific endpoint or a target service for a specific target object type.

When creating a rule using a rule builder, a user may choose to invoke a script with the rule is triggered and conditions in the rule are met. In an embodiment, a super user may create a script that is designed to add a new node if demand on a single node exceeds a maximum amount. The script may also contain an undo method to remove the extra node when demand drops again. The undo method corresponds to a cancel condition state defined in the rule. An individual user may choose to use this script when creating a rule.

In an embodiment, the SPM provides some global services owned by super users. In this embodiment, the SPM supports only services owned by super users. Individual users may only see a list of services in the rule builder and choose which services apply to the rule. The services name and owner may be displayed in the rule builder. A super user may add services that are global available to all users. A super user may also delete services and replace a service with another service or no services at all. If an in-use service is replaced, a notification may be automatically sent to rule owners. A super user may also prevent or allow services from displaying in a choose service panel in the rule builder.

### Conditional SLAs

SLAs specify a service level that a service provider will guarantee. For example, an SLA may guarantee a maximum response time. In some cases, an SLA may only be fulfilled if the service consumer adheres to specific conditions or obligations. For example, a loan processing service may be able to guarantee a 5-second response time, but only if the loan request rate does not exceed one per second.

This invention extends SLA specifications to include the notion of an obligation on the part of the service consumer. Thus an SLA is only required to be met if the service consumers meet the specified obligation or constraint. A consumer obligation is a measurable characteristic that cannot be controlled by the service provider, but can be monitored and acted upon if breached.

The source of a service provider's conditions may be internal (e.g., a limitation of the provider's physical capacity), or it may be a byproduct of the service provider's secondary role as a service consumer. In this latter case, a service provider that requires the use of another service provider to complete its task may propagate the secondary provider's obligations back to the initial service consumer. Consumer obligations may include, for example, request rate, request size, request form compliance, request content compliance (erroneous payload generating a large amount of faults), and response profile (valid payload generating abnormal backend load). Service provider obligations may include, for example, response time, throughput, error rate, and availability over a period of time.

Obligations differ fundamentally from ordinary SLA characteristics (such as guaranteed response time or availability) as they are not generally controlled by the service provider. Obligations can be used effectively in a number of scenarios. These scenarios include providing advanced warning that a service consumer is misbehaving; making a decision not to mitigate and provide additional provider computing resources if consumer obligation is not met; providing insight to SLA violations, and indicating remedial steps that identify and isolate the violation's source; and mitigating monetary impact when an SLA is violated due to unfulfilled consumer obligations.

### Patterns for Mitigation and Autoprotection

The SPM provides methods to mitigate the effect of misbehavior by any component of the system. Any components in the system, whether it is a consumer or provider of a service, may misbehave due to a hardware or software failure. The SPM can detect such situations by combining a number of factors originated from the consumer, provider, and infrastructure. Identifiable situations are consumer-bound, provider-bound, or infrastructure-bound.

Consumer bound situations include abnormal request size or throughput, erroneous payload generating a large amount of faults, and erroneous payload generating abnormal backend load. Provider bound situations include overloaded backend CPU, provider software failure, and deadlocks. Infrastructure bound situations include machine failure and network failure.

The SPM assesses the source of the problem by collecting metrics, detecting threshold violations, and identifying the source of the issue (machine, client, user app, service, etc.). The SPM has the ability to mitigate the effect of a misbehaving application through isolating the source of the issue through a blocking or throttling policy or removing the source of the issue if authorization permits.

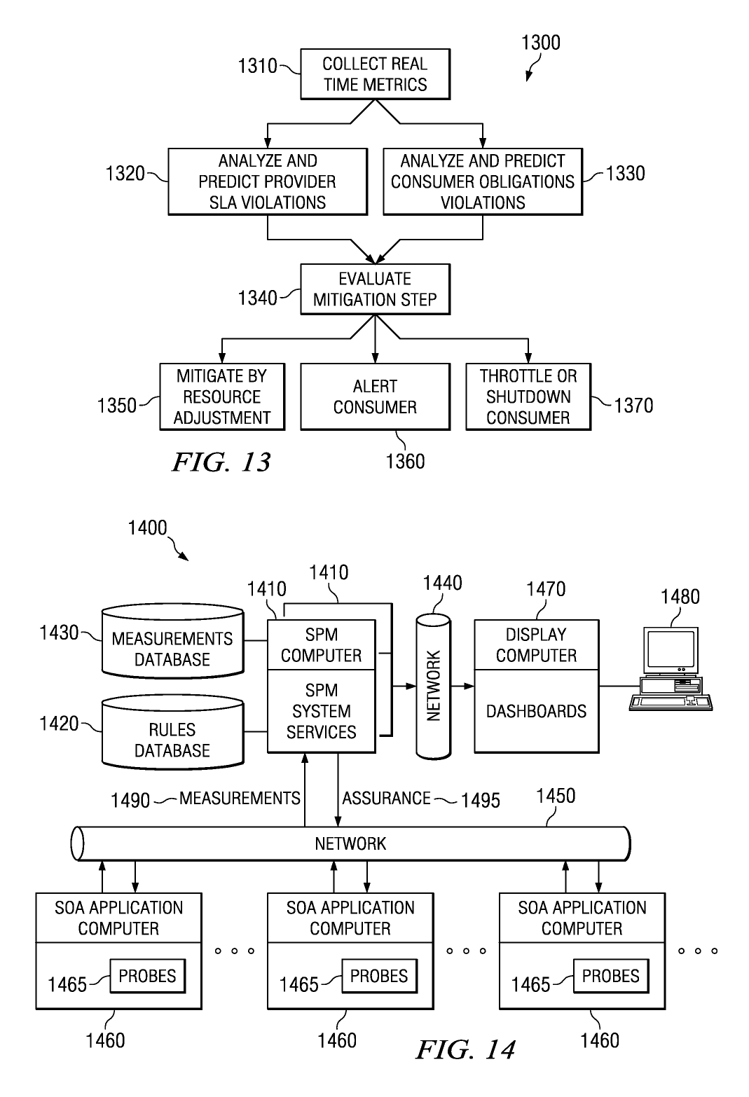

FIG. 13 is a flowchart 1300 illustrating service consumer obligation and their application to the service-oriented architecture autoprotection described in this application provides, as illustrated in Block 1310, for the collection of real-time metrics across the architecture. This action is labeled in the figure as “Collect Real Time Metrics,” and it provides for the gathering, aggregating, and analyzing of observational data in the architecture. These real-time metrics can be gathered at local-, host-level data points, as well as at a global level in which the host-level observational data can be aggregated and combined. By providing architecture-wide real-time metrics, significant improvements in the quality, significance, timeliness, and other favorable improvements in the metrics can be gained.

The service-oriented architecture in FIG. 13 will use the real-time metrics collected in Block 1310 to perform parallel analysis and prediction steps in Block 1320 and Block 1330, which are for analyzing and predicting provider SLA violations and analyzing and predicting consumer obligation violations, respectively. The analysis and prediction in Block 1320 relating to provider SLA violations helps the service-oriented architecture efficiently analyze, predict, and take actions based on the aggregated real-time metrics (from Block 1310). As mentioned, by virtue of aggregating the data at a global and local level, the system can achieve a higher level of granularity and accuracy with respect to specifically identifying problems in the resources being provided by the provider (which in turn helps predict possible provider SLA violations) at Block 1320. By the same principles, the system can also achieve better granularity and accuracy with respect to identifying problems in the consumer's performance according to the obligations imposed on the consumer when the consumer's obligation-bound SLA was submitted to the service-oriented architecture at Block 1330.

Once possible violations have been identified at Block 1320 and/or Block 1330, the service-oriented architecture includes an “Evaluate Mitigation Step” at Block 1340. Depending upon the violations identified, any of several steps can be taken as illustrated in Blocks 1350, 1360, and 1370. As illustrated in these respective action blocks, the violations can be addressed by: adding more resources, assigning different resources, or otherwise re-provisioning resources (as indicated in Block 1350); alerting the consumer to the problem, such that the consumer could resubmit the job, reconfigure the job, assign the job to another provider, or take some other action (as indicated in Block 1360); or throttle or shut down a consumer (or specifically an agent process/daemon) operating on a consumer computer (Block 1370).

FIG. 14 is a block diagram showing a system 1400 for implementing an embodiment of an SPM. In an embodiment, an SPM computer 1410 implementing features of an SPM includes a bus or other communications means for communicating information between the components of the SPM computer 1410. The SPM computer 1410 may further includes a processor coupled to the bus and a memory element, e.g., a random access memory (RAM) or other dynamic storage device also coupled to the bus. The memory element stores instructions for execution by the processor. The memory element may also store temporary variables. The SPM computer 1410 may include a mass storage device coupled to the bus for storing information that is not accessed as regularly as information stored in the memory element. The SPM computer 1410 may also include a communication device. If the SPM computer 1410 is implementing one portion of one embodiment of the system, then the communication device allows the SPM computer 1410 to communicate with other portions of the system, including all the services. The SPM computer 1410 may be a single SPM computer or may be multiple SPM computers.

Modules of the SPM system operate on the processor in the SPM computer 1410. Rules and measurements may be stored on databases 1420, 1430 and may be accessed by the SPM computer 1410 and implemented or used by the modules of the SPM system. The SPM computer 1410 sends and receives information through a network 1450 to and from one or more SOA application computers 1460. SPM probes 1465 are located on the SOA application computers 1460 and can monitor data pertinent to SOA platforms. In an embodiment, the probes are directly embedded inside the container infrastructure. Information gathered by the probes 1465 may be distributed to the SPM computer 1410 running the SPM system services, through a network 1450. Measurements and rules may be stored in databases 1420, 1430 and may be accessed by the SPM computer 1410. Results and metrics may be sent through a network 1440 to a display computer 1470. In an embodiment, a display computer 1470 may execute a dashboard, which may include displaying results and metrics on a dashboard console 1480. In an embodiment, the SPM computer 1410 may write update the display computer and the dashboard console, through the network 1440.

The SPM computer 1410 receives measurements 1490 through the network 1450 from system probes 1465 and sends assurances 1495 through the network to the SOA application computers 1460.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background of the Invention” is not to be construed as an admission that certain technology is prior art to any invention(s) in this disclosure. Neither is the “Brief Summary of the Invention” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A computer system implemented method for managing a service oriented architecture system, the method comprising:
discovering, in a computer processor, at least one service, the at least one service running in a service oriented architecture environment, the computer processor coupled through a communication bus to one or more memory elements, the computer processor communicating with other elements of the service oriented architecture system through a network interface;
measuring, in the computer processor, at least one observable event associated with the at least one service, the at least one observable event comprising at least one metric value measured by the computer processor in communication with the at least one service through the network interface;
analyzing, in the computer processor, the at least one observable event; and
predicting, in the computer processor, at least one behavior based on the analyzing of the at least one observable event.

2. The method of claim 1, further comprising:
managing, in the computer processor, the at least one service based upon the analyzing of the at least one observable event.

3. The method of claim 2, wherein the managing the at least one service comprises displaying the at least one metric value on a web-based dashboard, the web-based dashboard in communication with the computer processor through the network interface.

4. The method of claim 1, further comprising:
defining at least one rule and creating a schedule to run the at least one rule at a scheduled time.

5. The method of claim 4, wherein the at least one rule is stored on a database accessible by the computer processor.

6. The method of claim 4, further comprising:
selecting at least one target object for which to apply the at least one rule.

7. The method of claim 6, further comprising:
setting at least one condition on a metric available for the at least one target object.

8. The method of claim 7, further comprising:
defining at least one action; and
associating the at least one action with one of the at least one rule or the at least one condition.

9. The method of claim 1, further comprising:
sending at least one alert from the computer processor through the network interface to a display.

10. The method of claim 1, further comprising:
executing at least one action.

11. The method of claim 1, wherein the at least one service comprises a grouped service.

12. The method of claim 1, wherein the discovering at least one service comprises discovering a service level agreement defined on the at least one service.

13. The method of claim 1, wherein the at least one observable event comprises a plurality of observable events and the at least one metric value comprises a plurality of metric values, and wherein the predicting at least one behavior comprises analyzing statistical and time-based data compiled from the plurality of observable events and metric values.

14. A service performance manager system for managing a service oriented architecture system, the system comprising:
at least one communication bus;
one or more memory elements;
a computer processor, the computer processor coupled through the at least one communication bus to the one or more memory elements, the computer processor communicating with other elements of the service oriented architecture system through a network interface, the computer processor operable with computer code stored in the one or more memory elements to provide a plurality of operating software modules comprising:
a service discovering module operative to discover, in the computer processor, at least one service running in a service oriented architecture environment;
an observable event measuring module operative to measure, in the computer processor, at least one observable event associated with the at least one service, the at least one observable event comprising at least one metric value measured by the computer processor in communication with the at leas tone service through the network interface;
an observable event analyzing module operative to analyze, in the computer processor, the at least one observable event; and
a behavior predicting module operative to predict, in the computer processor, at least one behavior based on the analysis of the observable event analyzing module.

15. The service performance manager system of claim 14, wherein the computer processor is further operable with computer code stored in the one or more memory elements to provide a service managing module operative to manage, in the computer processor, the at least one service based upon the analyzing of the observed event.

16. The service performance manager system of claim 14, wherein the computer processor is further operable with computer code stored in the one or more memory elements to provide an executing action module operative to execute at least one action.

17. The service performance manager system of claim 16, wherein executing the at least one action comprises sending an alert from the computer processor through the network interface to a display.

18. The service performance manager system of claim 14, further comprising:
a web-based dashboard operative to display at least one metric value, the web-based dashboard in communication with the computer processor through the network interface.

19. The service performance manager system of claim 14, wherein the computer processor is further operable with computer code stored in the one or more memory elements to provide a rule defining module operative to define at least one rule.

20. The service performance manager system of claim 19, wherein the rule defining module is further operative to select at least one target object for which to apply the at least one rule.

21. The service performance manager system of claim 20, wherein the rule defining module is further operative to set at least one condition on a metric available for the at least one target.

22. The service performance manager system of claim 21, wherein the rule defining module is further operative to define at least one action and associate the at least one action with one of the at least one rule or the at least one condition.
